(19) United States
(12) Patent Application Publication
(10) Pub. No.: US 2025/0260150 A1
(43) Pub. Date: Aug. 14, 2025

(54) PHASE SHIFTER AND ANTENNA DEVICE

(71) Applicant: NEC Corporation, Tokyo (JP)

(72) Inventors: Ryota NIHEI, Tokyo (JP); Kohei YOSHIDA, Tokyo (JP); Okumura FUJIO, Kanagawa (JP)

(73) Assignee: NEC Corporation, Tokyo (JP)

(21) Appl. No.: 18/999,037

(22) Filed: Dec. 23, 2024

(30) Foreign Application Priority Data
Feb. 9, 2024 (JP) 2024-018568

(51) Int. Cl. H01P 1/18; H01Q 3/36; H01Q 21/06

(52) U.S. Cl. CPC H01P 1/18; H01Q 3/36; H01Q 21/065

(57) ABSTRACT

A phase shifter including a 90 degree hybrid circuit having two reflection ends, a variable stub having a line formation layer made of vanadium dioxide and extending from each of the two reflection ends, and a ground pattern formed with a groove in which the variable stub is disposed and connected to a side end of the variable stub disposed in the groove.

This application is based upon and claims the benefit of priority from Japanese Patent Application No. 2024-018568, filed on Feb. 9, 2024, the disclosure of which is incorporated herein in its entirety by reference.

### TECHNICAL FIELD

The present disclosure relates to a phase shifter and an antenna device.

### BACKGROUND ART

For mobile communication after the fifth generation mobile communication, an antenna device compatible with radio waves in a high frequency band has been developed. For example, examples of such an antenna device include a phased array antenna configured by a plurality of antenna elements. The phased array antenna can form a beam having a desired directivity by changing an excitation phase of an antenna element using a phase shifter mounted on a pre-stage of the antenna element. For example, since a phase shift range up to 360 degrees can be covered by using a switched line phase shifter, in such a way that a large scanning angle can be achieved. However, it is difficult to incorporate such a phase shifter in a small antenna device having a plurality of patch antennas.

PTL 1 (Japanese Patent Application Laid-Open No. 2019-029722) discloses a reflection-type variable phase shifter intended to continuously change a phase. The variable phase shifter of PTL 1 includes a 90 degree hybrid circuit, a pair of switches, a pair of first variable reactance elements, a pair of first stubs, and a pair of second variable reactance elements. The 90 degree hybrid circuit has a first port, a second port, a third port, and a fourth port. With respect to an input of a signal from the first port, the 90 degree hybrid circuit outputs the signal to the second port and the third port with a phase difference of 90 degrees and does not output the signal to the fourth port. The switch is provided in each of the second port and the third port. The first variable reactance element is connected to each of the pair of switches. The switch is connected to one end of the first stub. The second variable reactance element is connected to the other end of the first stub. The switch switches between connection with the first variable reactance element and connection with one end of the first stub.

According to the variable phase shifter of PTL 1, the phase shift amount can be changed by switching the connection between the second port and the third port of the 90 degree hybrid circuit and the variable reactance element and the stub. According to the variable phase shifter of PTL 1, a continuous phase shift change can be achieved by continuously changing the capacitance by applying a reverse voltage to the variable reactance element. However, in the variable phase shifter of PTL 1, it is necessary to finely control the reverse voltage to be applied to the variable reactance element, and it is difficult to obtain a stable phase shift amount.

An object of the present disclosure is to provide a phase shifter and an antenna device capable of achieving continuous phase shift change with a stable phase shift amount.

### SUMMARY

A phase shifter according to an aspect of the present disclosure includes a 90 degree hybrid circuit having two reflection ends, a variable stub having a line formation layer made of vanadium dioxide and extending from each of the two reflection ends, and a ground pattern formed with a groove in which the variable stub is disposed and connected to a side end of the variable stub disposed in the groove.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a phase shifter according to the present disclosure;

FIG. 2 is a conceptual diagram for explaining an example of a 90 degree hybrid circuit according to the present disclosure;

FIG. 3 is a conceptual diagram in which a portion of a variable stub according to the present disclosure is enlarged;

FIG. 4 is a conceptual diagram for explaining a configuration of the variable stub according to the present disclosure;

FIG. 5 is a conceptual diagram illustrating an example of a configuration of the variable stub according to the present disclosure;

FIG. 6 is a conceptual diagram illustrating an example of a configuration of the variable stub according to the present disclosure;

FIG. 7 is a conceptual diagram illustrating an example of a circuit configuration of a heat generation drive circuit according to the present disclosure;

FIG. 8 is a block diagram illustrating an example of a configuration of an antenna device including a phase shifter according to the present disclosure;

FIG. 9 is a conceptual diagram illustrating an example in which a conductive portion (line) is formed in the variable stub according to the present disclosure;

FIG. 10 is a conceptual diagram in which a conductive portion (line) formed in the variable stub according to the present disclosure is enlarged;

FIG. 11 is a conceptual diagram in which a conductive portion (line) formed in the variable stub according to the present disclosure is enlarged;

FIG. 12 is a conceptual diagram illustrating an example of a cross section in an extended line region of a conductive portion (line) formed in the variable stub according to the present disclosure;

FIG. 13 is a conceptual diagram illustrating an example of a cross-section in a grounded line region of a conductive portion (line) formed in the variable stub according to the present disclosure;

FIG. 14 is a conceptual diagram illustrating an example of a conductor pattern formed on the variable stub according to the present disclosure;

FIG. 15 is a conceptual diagram illustrating an example of a conductor pattern formed on the variable stub according to the present disclosure;

FIG. 16 is a conceptual diagram illustrating an example of a conductor pattern formed on the variable stub according to the present disclosure;

FIG. 17 is an example of a table used to select a conductor pattern formed on the variable stub according to the present disclosure;

FIG. 18 is a conceptual diagram illustrating an example of a configuration of a phase shifter according to the present disclosure;

FIG. 19 is a conceptual diagram illustrating an example of a configuration of a phase shifter according to the present disclosure;

FIG. 20 is a conceptual diagram illustrating an example of a configuration of a phase shifter according to the present disclosure;

FIG. 21 is a conceptual diagram illustrating an example of a configuration of a phase shifter according to the present disclosure;

FIG. 22 is a conceptual diagram illustrating an example of a configuration of a phase shifter according to the present disclosure;

FIG. 23 is a conceptual diagram illustrating an example of a configuration of the antenna device according to the present disclosure;

FIG. 24 is a conceptual diagram illustrating an example of a configuration of an antenna device according to the present disclosure;

FIG. 25 is a conceptual diagram illustrating an example of a matrix circuit formed on an upper surface of a substrate according to the present disclosure;

FIG. 26 is a conceptual diagram illustrating an example of a configuration of an antenna device according to the present disclosure;

FIG. 27 is a block diagram illustrating an example of a functional configuration of the antenna device according to the present disclosure;

FIG. 28 is a conceptual diagram illustrating an example of a configuration of a phase shifter according to the present disclosure; and

FIG. 29 is a block diagram illustrating an example of a hardware configuration that executes control according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a phase shifter according to a first example embodiment will be described with reference to the drawings. For example, the phase shifter of the present example embodiment is mounted on an antenna device including a patch antenna, which is a type of planar antenna. The phase shifter of the present example embodiment can be applied to transmission of a transmission target radio wave and reception of a reception target radio wave arriving from the outside. For example, the phase shifter of the present example embodiment can be applied to an antenna device used for transmission and reception of a transmission/reception target signal in a high frequency band used in mobile communication after the fifth generation mobile communication. Hereinafter, the electrical length of the transmission/reception target signal on a substrate is denoted by 2 (2 is a real number).

### (Configuration)

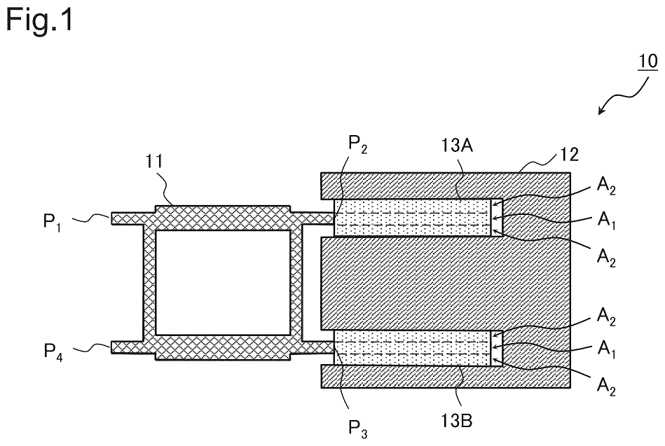

FIG. 1 is a conceptual diagram illustrating an example of a configuration of a phase shifter according to the present disclosure. The phase shifter 10 includes a 90 degree hybrid circuit 11, a ground pattern 12, a variable stub 13A and a variable stub 13B. The variable stub 13A and the variable stub 13B have similar configuration. Hereinafter, when the variable stub 13A and the variable stub 13B are not distinguished from each other, they are referred to as variable stubs 13.

The 90 degree hybrid circuit 11 is a 90 degree hybrid circuit including 4 transmission lines. Each of the four transmission lines forms one side of a quadrangle. A port is formed at each vertex of a quadrangle formed by the four transmission lines included in the 90 degree hybrid circuit 11. The 90 degree hybrid circuit 11 includes a first port P₁, a second port P₂, a third port P₃, and a fourth port P₄. The first port P₁ is an input end. The first port P₁ receives a phase shift target signal. The second port P₂ is a reflection end (also referred to as a first reflection end). The variable stub 13A is connected to the second port P₂. The third port P₃ is a reflection end (also referred to as a second reflection end). The variable stub 13B is connected to the third port P₃. The fourth port P₄ is an output end. The phase-shifted signal is output from the fourth port P₄.

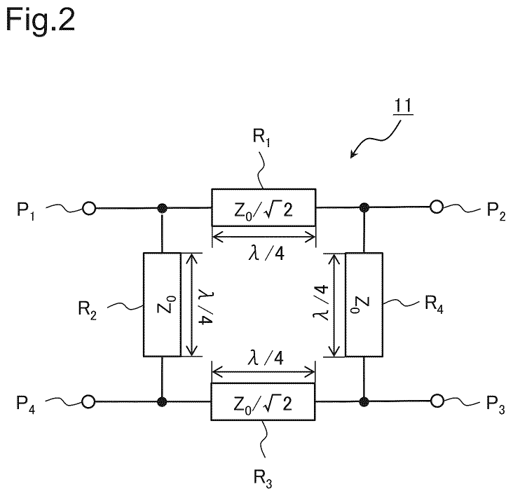

FIG. 2 is a conceptual diagram for explaining a 90 degree hybrid circuit according to the present disclosure. The 90 degree hybrid circuit 11 includes four transmission lines (R₁, R₂, R₃, R₄). The electrical length of each of the four transmission lines (R₁, R₂, R₃, R₄) is 2/4 (90 degrees). FIG. 2 is a diagram conceptually illustrating a 90 degree hybrid circuit according to the present disclosure, and is not a diagram accurately illustrating a structure of the 90 degree hybrid circuit.

The transmission line R₁ is a transmission line having an electrical length of N/4. The characteristic impedance of the transmission line R₁ is Z₀/√2. The first end of the transmission line R₁ is connected to the first port P₁ (input end). Furthermore, the first end of the transmission line R₁ is connected to the first end of the transmission line R₂. The second end of the transmission line R₁ is connected to the first end of the transmission line R₄. Furthermore, the second end of the transmission line R₁ is connected to the second port P₂. The variable stub 13A is connected to the second port P₂.

The transmission line R₂ is a transmission line having an electrical length of λ/4. The characteristic impedance of the transmission line R₂ is Z₀. The first end of the transmission line R₂ is connected to the first port P₁ (input end). Furthermore, the first end of the transmission line R₂ is connected to the first end of the transmission line R₁.

The second end of the transmission line R₂ is connected to the fourth port P₄ (output end). The second end of the transmission line R₂ is connected to the first end of the transmission line R₃ .

The transmission line R₃ is a transmission line having an electrical length of λ/4.

The characteristic impedance of the transmission line R₂ is Z₀/√2. The first end of the transmission line R₃ is connected to the fourth port P₄ (output end). The first end of the transmission line R₃ is connected to the second end of the transmission line R₂. The second end of the transmission line R₃ is connected to the second end of the transmission line R₄ . Furthermore, the second end of the transmission line R₃ is connected to the third port P₃. The variable stub 13B is connected to the third port P₃.

The transmission line R₄ is a transmission line having an electrical length of λ/4. The characteristic impedance of the transmission line R₄ is Z₀. The first end of the transmission line R₄ is connected to the second end of the transmission line R₁. Furthermore, the first end of the transmission line R₄ is connected to the second port P₂.

One of the variable stubs 13A is connected to the second port P₂. The second end of the transmission line R₄ is connected to the second end of the transmission line R₃ . Furthermore, the second end of the transmission line R₄ is connected to the third port P₃. The variable stub 13B is connected to the third port P₃.

The ground pattern 12 is a pattern made of a conductor. For example, a material of the ground pattern 12 is metal (including alloy) such as copper, aluminum, and chromium. The ground pattern 12 is electrically connected to a housing or the like set to a ground potential. The potential of the ground pattern 12 is a ground potential. A pair of grooves is formed in the ground pattern 12. The pair of grooves formed in the ground pattern 12 has a shape extending from the second port P₂ and the third port P₃ of the 90 degree hybrid circuit 11. Each of the variable stub 13A and the variable stub 13B is disposed in each of the pair of grooves formed in the ground pattern 12. Inside the pair of grooves formed in the ground pattern 12, the variable stub 13A and the variable stub 13B are arranged in such a way as to be in contact with the ground pattern 12.

The variable stub 13A and the variable stub 13B are stubs having a line formation layer composed of vanadium dioxide VO₂. The variable stub 13A and the variable stub 13B are stubs in which a line length utilizing the phase transition between the insulating phase and the metal phase of the vanadium dioxide VO₂ is variable. Vanadium dioxide VO₂ contained in the line formation layer is an insulating layer at a temperature lower than the phase transition temperature T. When the phase transition temperature T is exceeded, the vanadium dioxide VO₂ contained in the insulating phase line formation layer undergoes phase transition from the insulating phase to the metal phase. The line length of the variable stub 13 changes according to the state of phase transition of the vanadium dioxide VO₂ constituting the variable stub 13.

The variable stub 13A is disposed inside one groove (upper side in FIG. 1) formed in the ground pattern 12. The first end of the variable stub 13A is connected to the second port P₂ of the 90 degree hybrid circuit 11. That is, the first end of the variable stub 13A is connected to the second end of the transmission line R₁ and the first end of the transmission line R₄ via the second port P₂. A side end of the variable stub 13A is connected to the ground pattern 12. The second end of the variable stub 13A may be connected to the ground pattern 12 or may not be connected to the ground pattern 12.

The variable stub 13B is disposed inside the other groove (the lower side in FIG. 1) formed in the ground pattern 12. The first end of the variable stub 13B is connected to the third port P₃ of the 90 degree hybrid circuit 11. That is, the first end of the variable stub 13B is connected to the second end of the transmission line R₃ and the second end of the transmission line R₄ via the third port P₃. A side end of the variable stub 13B is connected to the ground pattern 12. The second end of the variable stub 13B may be connected to the ground pattern 12 or may not be connected to the ground pattern 12.

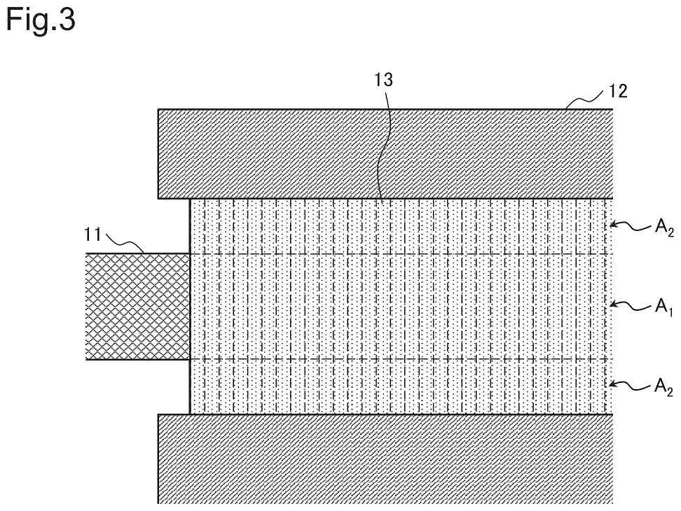

FIG. 3 is a conceptual diagram in which a portion of a variable stub according to the present disclosure is enlarged. In the variable stub 13, an extended line region A₁ and a grounded line region A₂ are formed. The extended line region A₁ is a region where a line extending from the reflection end of the 90 degree hybrid circuit 11 is formed. The line length of the variable stub 13B is set according to the length of the conductive portion formed in the extended line region A₁. The grounded line region A₂ is a region where a line for grounding the line extended in the extended line region A₁ to the ground pattern 12 is formed. The variable stub 13 functions as a short stub by grounding the end portion of the conductive portion formed in the extended line region A₁ to the ground pattern 12 at the portion formed in the grounded line region A₂. For example, the variable stub 13 can be caused to function as an open stub without grounding the end portion of the conductive portion formed in the extended line region A₁.

### [Variable Stub]

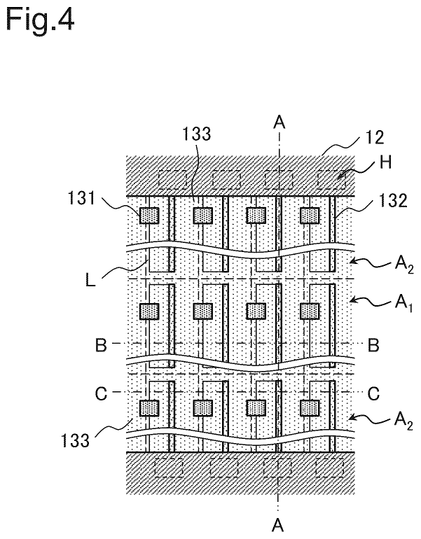

FIG. 4 is a conceptual diagram for explaining a configuration of the variable stub according to the present disclosure. FIG. 4 illustrates a line formation layer, a heat generation drive circuit, and a heat generating element constituting the variable stub. The heat generation drive circuit 131 and the heat generating element 132 are arrayed in a two-dimensional array form. One heat generating element 132 is associated with one heat generation drive circuit 131. The heat generation of the heat generating element 132 is controlled via the wiring L connected to the associated heat generation drive circuit 131. The line formation layer 133 is disposed above the heat generation drive circuit 131 and the heat generating element 132. In FIG. 4, illustration is made such that the line formation layer 133 is located below the heat generation drive circuit 131 and the heat generating element 132, but in practice, the line formation layer 133 is located above the heat generation drive circuit 131 and the heat generating element 132. Furthermore, in FIG. 4, contact hole H (broken-line frame) is shown in a ground pattern 12. The contact hole His an opening for electrically connecting the ground pattern 12 and the line formation layer 133.

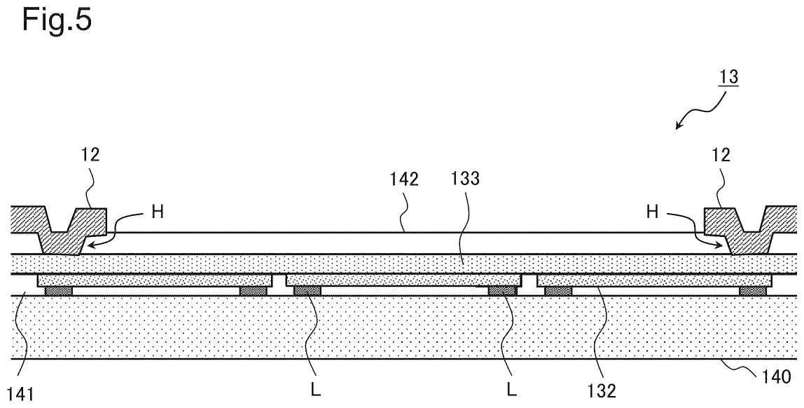

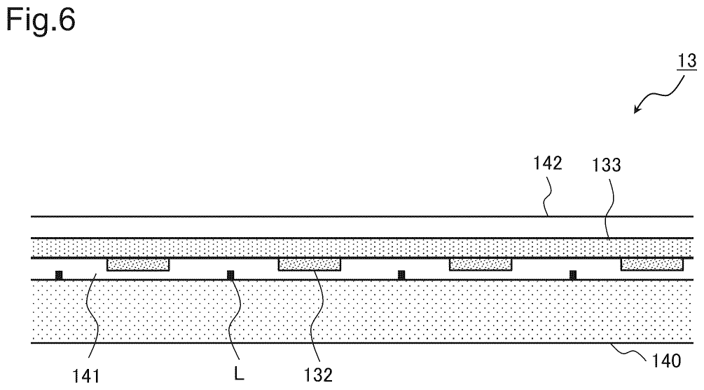

FIGS. 5 and 6 are conceptual diagrams illustrating an example of a configuration of a variable stub according to the present disclosure. FIG. 5 illustrates a cross-sectional view of the variable stub taken along a cutting line A-A in FIG. 4. The cutting line A-A is a cutting line for cutting the variable stub 13 in a short direction (up-down direction in the plane of drawing). The cutting line A-A passes through the heat generating element 132. FIG. 6 illustrates a cross-sectional view of the variable stub taken along a cutting line B-B or a cutting line C-C in FIG. 4. The cutting line B-B and the cutting line C-C are cutting lines for cutting the variable stub 13 in a longitudinal direction (left-right direction in the plane of drawing). The cutting line B-B is a cutting line for cutting a position including the wiring L in the extended line region A₁. The cutting line C-C is a cutting line for cutting a position including the wiring L in the grounded line region A₂.

The variable stub 13 includes a plurality of heat generation drive circuits 131, a plurality of heat generating elements 132, and a line formation layer 133. The variable stub 13 is formed on the substrate 140. For example, the substrate 140 is a plate-like member having an insulating property such as glass or epoxy resin. A matrix circuit of thin film transistors (TFTs) including a plurality of heat generation drive circuits 131 and a plurality of wirings L is formed on the upper surface of substrate 140. The plurality of wirings L electrically connect the heat generation drive circuit 131 and the heat generating element 132. The line formation layer 133 is formed above the plurality of heat generating elements 132. The substrate 140 and the line formation layer 133 are insulated from each other by a first insulating layer 141. A second insulating layer 142 is formed on the upper surface of the line formation layer 133. A contact hole His formed in the second insulating layer 142 above the side end of the line formation layer 133. The line formation layer 133 is electrically connected to the ground pattern 12 via the contact hole H.

The plurality of heat generation drive circuits 131 are formed on the upper surface of the substrate 140. The plurality of heat generation drive circuits 131 are formed in a two-dimensional array form in plan view of the upper surface of the substrate 140. The plurality of heat generation drive circuits 131 are isolated by the first insulating layer 141. Each of the plurality of heat generation drive circuits 131 is associated with one heat generating element 132. Each of the plurality of heat generation drive circuits 131 is used for temperature control of the associated heat generating element 132.

Each of the plurality of heat generating elements 132 is associated with one heat generation drive circuit 131. The heat generating element 132 is disposed obliquely above the associated heat generation drive circuit 131. The heat generating element 132 may be disposed at a position not obliquely above the associated heat generation drive circuit 131. The heat generating element 132 is electrically connected to the associated heat generation drive circuit 131 via the wiring L. The line formation layer 133 is formed on the upper surfaces of the plurality of heat generating elements 132. The plurality of heat generating elements 132 are isolated by the first insulating layer 141. The plurality of heat generating elements 132 may be isolated by a gap formed in the first insulating layer 141. The heat generating element 132 is used to heat the line formation layer 133 on the upper side. For example, the heat generating element 132 is achieved by an alloy having nickel Ni or chromium Cr as a main component. The heat generating element 132 may be achieved by an alloy having chromium Cr, iron Fe, and aluminum Al as main components. The material of the heat generating element 132 is not particularly limited. When current is supplied, the temperature of the heat generating element 132 rises. For example, supply of current to the heat generating element 132 can be controlled using a thin film transistor (TFT). The heat of the heat generating element 132 is transferred to the line formation layer 133.

The line formation layer 133 is disposed above the plurality of heat generating elements 132. The lower surface of the line formation layer 133 and the upper surfaces of the plurality of heat generating elements 132 are thermally connected. The lower surface of the line formation layer 133 and the upper surfaces of the plurality of heat generating elements 132 are preferably in contact with each other. As long as the heat of the heat generating element 132 can be transferred to the line formation layer 133 and the phase transition can be controlled, another layer may be interposed between the lower surface of the line formation layer 133 and the upper surfaces of the plurality of heat generating elements 132. The line formation layer 133 is partially heated by the heat generating element 132 at the position on the lower side generating heat.

The line formation layer 133 contains vanadium dioxide VO₂. In the line formation layer 133, a line having electrical conductivity is formed by phase transition of an insulating phase-metal phase of vanadium dioxide VO₂. Vanadium dioxide VO₂ contained in the line formation layer 133 has a composition that undergoes a phase transition from an insulating phase to a metal phase at a phase transition temperature T. At a temperature lower than the phase transition temperature T, the vanadium dioxide VO₂ is an insulating phase. At a temperature lower than the phase transition temperature T, electricity does not flow through the vanadium dioxide VO₂. At a temperature higher than the phase transition temperature T, the vanadium dioxide VO₂ is a metal phase. At a temperature higher than the phase transition temperature T, electricity flows through the vanadium dioxide VO₂. The phase transition of vanadium dioxide VO₂ exhibits hysteresis in temperature rise and temperature fall. Therefore, the phase transition of the insulating phase-metal phase of vanadium dioxide VO₂ is adjusted in a temperature range including the phase transition temperature T.

For example, the line formation layer 133 may have a line formation layer containing vanadium dioxide VO₂ to which no additive element is added. For example, an additive element may be added to vanadium dioxide VO₂ contained in the line formation layer 133. For example, an additive element for lowering the phase transition temperature may be added to vanadium dioxide VO₂ contained in the line formation layer 133. When an additive element such as tungsten W, magnesium Mg, iron Fe, molybdenum Mo, fluorine F, or niobium Nb is added, the phase transition temperature of vanadium dioxide VO₂ lowers.

The first insulating layer 141 is formed on the upper surface of the substrate 140. The first insulating layer 141 covers the sides of the heat generation drive circuit 131 and the heat generating element 132. The line formation layer 133 is disposed above the first insulating layer 141. For example, the first insulating layer 141 is made of a general interlayer insulating material. For example, the first insulating layer 141 is made of an inorganic material such as silicon dioxide. The material of the first insulating layer 141 may be an organic material.

The second insulating layer 142 is formed above the line formation layer 133. For example, the second insulating layer 142 is made of a general interlayer insulating material. For example, the second insulating layer 142 is formed of a material such as silicon dioxide. A contact hole H is formed in the second insulating layer 142 above the side end of the line formation layer 133. The line formation layer 133 and the ground pattern 12 are electrically connected via the contact hole H.

### [Heat Generation Drive Circuit]

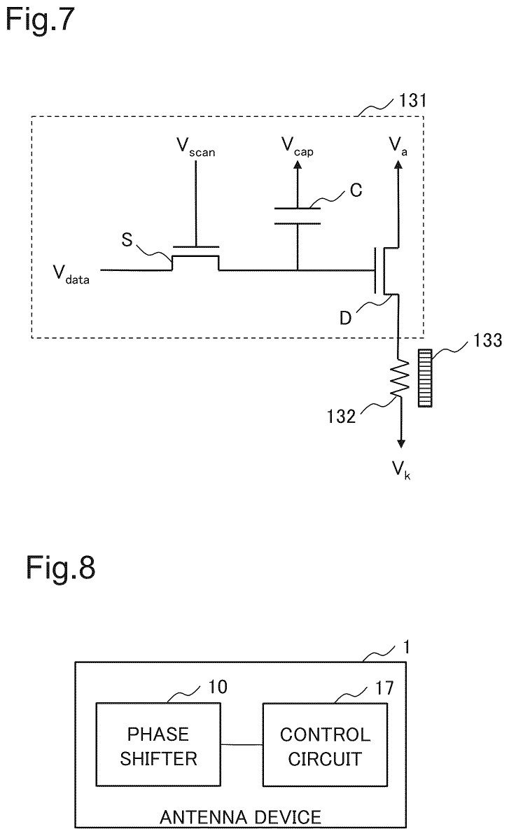

FIG. 7 is a conceptual diagram illustrating an example of a circuit configuration of a heat generation drive circuit according to the present disclosure. The heat generation drive circuit 131 includes a transistor S, a transistor D, and a capacitor C. FIG. 7 illustrates an example in which the heat generating element 132 is achieved by a resistance element. Hereinafter, a connection relationship among the transistor S, the transistor D, the capacitor C, and the heat generating element 132 will be described. In the following description, directions in the plane of drawing of FIG. 7 are shown in parentheses. FIG. 7 illustrates an example of the circuit configuration of the heat generation drive circuit according to the present disclosure, and does not limit the circuit configuration of the heat generation drive circuit.

The transistor S is used to select the heat generating element 132. A first end (left side) of the diffusion layer of the transistor S is connected to a supply source of the voltage V_{data}. The second end (right side) of the diffusion layer of the transistor S is connected to the first electrode (lower side) of the capacitor C and the gate (left side) of the transistor D. The gate (upper side) of the transistor S is connected to a supply source of the voltage V_{scan}.

The capacitor C is used to control the voltage applied to the gate of the transistor D. The first electrode (lower side) of the capacitor C is connected to the second end (right side) of the diffusion layer of the transistor S and the gate (left side) of the transistor D. The second electrode (upper side) of the capacitor C is connected to a supply source of the voltage V_{cap}. A voltage V_{cap} is applied to the second electrode (upper side) of the capacitor C.

The transistor D is used to control the voltage to be supplied to the heat generating element 132. A first end (upper side) of the diffusion layer of the transistor D is connected to a supply source of the voltage Vₐ. The voltage Vₐ is applied to the first end (upper side) of the diffusion layer of the transistor D. The second end (lower side) of the diffusion layer of the transistor D is connected to the first electrode (lower side) of the heat generating element 132. The gate (left side) of the transistor D is connected to the second end (right side) of the diffusion layer of the transistor S and the first end (lower side) of the capacitor C.

The first end (upper side) of the heat generating element 132 is connected to the second end (lower side) of the diffusion layer of the transistor D. The second end (lower side) of the heat generating element 132 is connected to a supply source of the voltage Vₖ. The voltage Vₖ is applied to the second end (lower side) of the heat generating element 132. When the transistor S transitions to an ON state by the application of the voltage V_{scan}, a voltage that is a difference between the voltage V_{data} and the voltage V_{cap} is applied to the capacitor C. When charging of the capacitor C is completed, the transistor S transitions to an OFF state. After the transistor S transitions to the OFF state, the capacitor C holds the voltage, and the transistor D continues to maintain the ON state according to the potential. In an ON state of the transistor D, a current corresponding to a voltage corresponding to a potential difference between the voltage Vₐ and the voltage Vₖ and a resistance value of the heat generating element 132 flows, and the heat generating element 132 generates heat. The heat generated in the heat generating element 132 is transferred to the line formation layer 133 in thermal contact with the heat generating element 132.

FIG. 8 is a block diagram illustrating an example of a configuration of an antenna device including a phase shifter according to the present disclosure. The antenna device 1 includes a phase shifter 10 and a control circuit 17. The control circuit 17 is a circuit for controlling the phase shifter 10. For example, the control circuit 17 is achieved by a microcomputer including a processor and a memory. The control circuit 17 controls the heat generation drive circuit 131 included in the variable stub 13 of the phase shifter 10 to control the conductor pattern of the line formation layer 133. The capacitance of the variable stub 13 is adjusted according to the control of the control circuit 17. The control circuit 17 may be configured as a component of the phase shifter 10.

### [Line Formation]

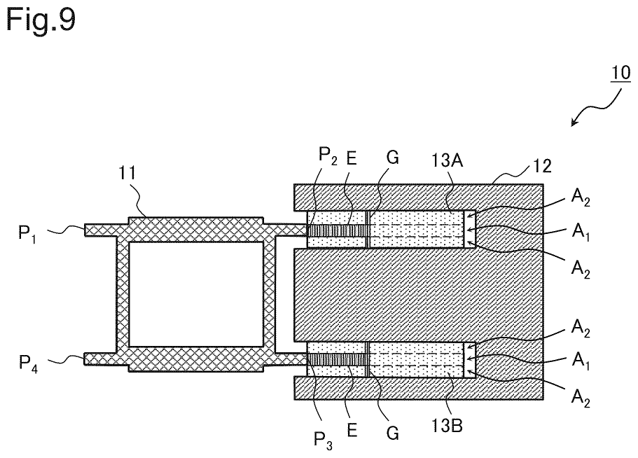

Next, the line formation control in the variable stub 13 will be described with reference to the drawings. FIGS. 9 to 13 are conceptual diagrams for explaining an example of the line formation control of the variable stub according to the present disclosure.

FIG. 9 is a conceptual diagram illustrating an example in which a conductive portion (line) is formed in the variable stub according to the present disclosure. FIG. 9 is a plan view of the variable stub viewed from an upper viewpoint. The extended line E and the grounded line G are conductive portions formed in the line formation layer 133. The extended line E and the grounded line G are indicated by hatching different from that of the non-conductive portion. The extended line E is formed in the extended line region A₁. The extended line E is extended in the extended line region A₁ starting from a contact area (left side in the plane of drawing) with the reflection ends (the second port P₂ and the third port P₃) of the 90 degree hybrid circuit 11. The grounded line G is formed in the grounded line region A₂. The grounded line G is formed between the terminal end (right side in the plane of drawing) of the extended line E and the ground pattern 12. The grounded line G electrically connects the terminal end (right side in the plane of drawing) of the extended line E and the ground pattern 12.

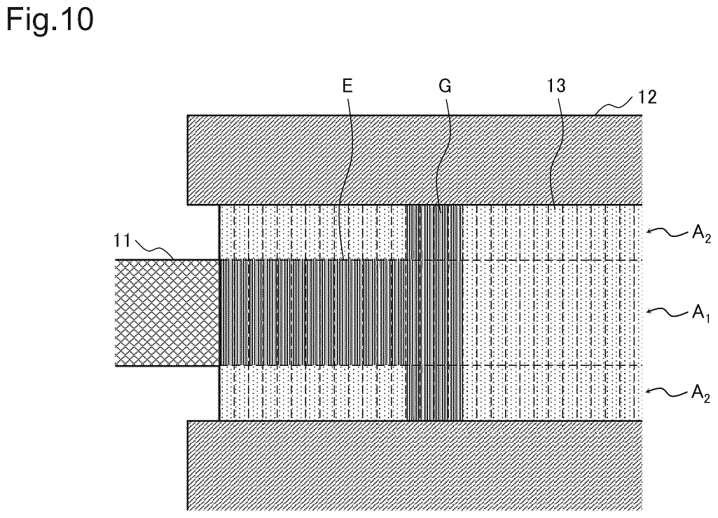

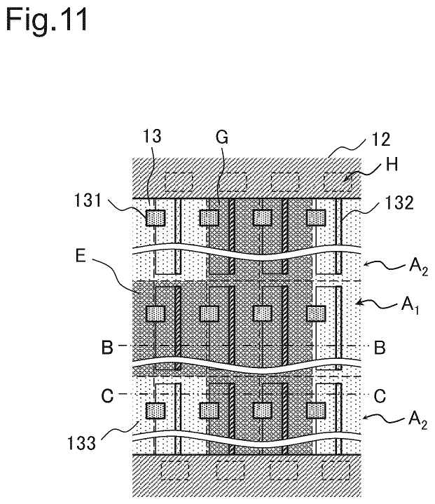

FIGS. 10 to 11 are conceptual diagrams in which a conductive portion (line) formed in the variable stub according to the present disclosure is enlarged. FIGS. 10 to 11 are plan views of the variable stub viewed from an upper viewpoint. FIG. 11 illustrates a line formation layer, a heat generation drive circuit, and a heat generating element constituting the variable stub. In FIGS. 10 to 11, the heat generation unit region in the variable stub 13 is indicated by a region divided by a broken line. One heat generating element is assigned to the heat generation unit region.

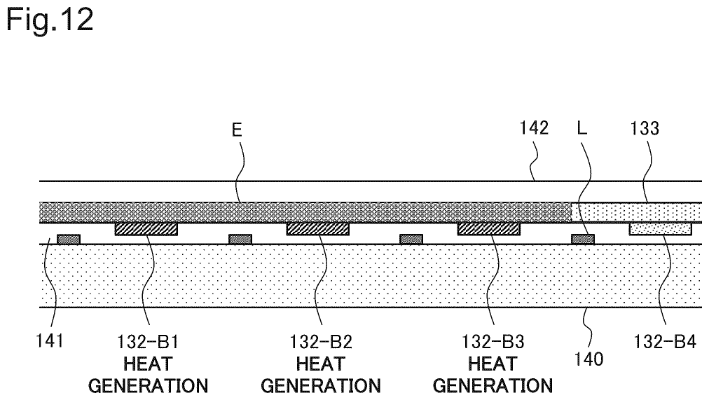

FIG. 12 is a conceptual diagram illustrating an example of a cross section in an extended line region of a conductive portion (line) formed in the variable stub according to the present disclosure. FIG. 12 illustrates a cross-sectional view of the variable stub taken along a cutting line B-B in FIG. 11. The cutting line B-B is a cutting line for cutting a position including the wiring L in the extended line region A₁. FIG. 12 illustrates a plurality of heat generating elements. The heat generating element 132-B1, the heat generating element 132-B2, and the heat generating element 132-B3 generate heat to a temperature exceeding the phase transition temperature of the vanadium dioxide VO₂ contained in the variable stub 13. The heat generating element 132-B4 does not generate heat. The vanadium dioxide VO₂ contained in the variable stub 13 located above the heat generating element 132-B1, the heat generating element 132-B2, and the heat generating element 132-B3 is phase transitioned to the metal phase. Therefore, the extended line E is formed in the variable stub 13 at a position above the heat generating element 132-B1, the heat generating element 132-B2, and the heat generating element 132-B3.

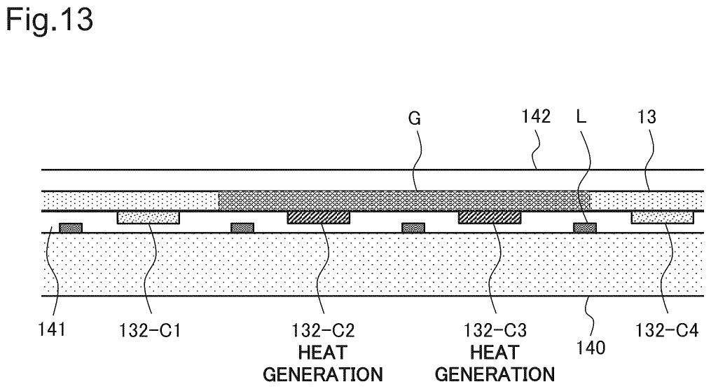

FIG. 13 is a conceptual diagram illustrating an example of a cross-section in a grounded line region of a conductive portion (line) formed in the variable stub according to the present disclosure. FIG. 13 illustrates a cross-sectional view of the variable stub taken along a cutting line C-C in FIG. 11. The cutting line C-C is a cutting line for cutting a position including the wiring L in the grounded line region A₂. FIG. 13 illustrates a plurality of heat generating elements. The heat generating element 132-C2 and the heat generating element 132-C3 generate heat to a temperature exceeding the phase transition temperature of the vanadium dioxide VO₂ contained in the variable stub 13. The heat generating element 132-C1 and the heat generating element 132-C4 do not generate heat. The vanadium dioxide VO₂ contained in the variable stub 13 located above the heat generating element 132-C2 and the heat generating element 132-C3 is phase transitioned to the metal phase. Therefore, the grounded line G is formed in the variable stub 13 at a position above the heat generating element 132-C2 and the heat generating element 132-C3.

As illustrated in FIGS. 12 to 13, the extended line E and the grounded line G are formed in the variable stub 13 by the plurality of heat generating elements 132 generating heat. The terminal end of the extended line E is connected to the ground pattern 12 by the grounded line G. As a result, the variable stub 13 functions as a short stub extended by the length of the extended line E. For example, it is also possible to form the extended line E and not to form the grounded line G. In such a case, the variable stub 13 functions as an open stub extended by the length of the extended line E.

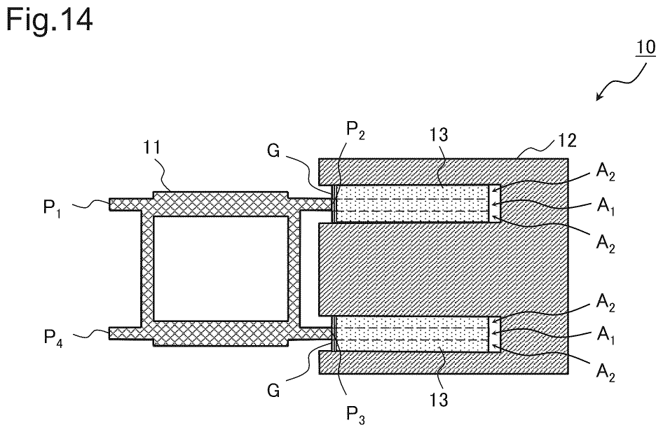

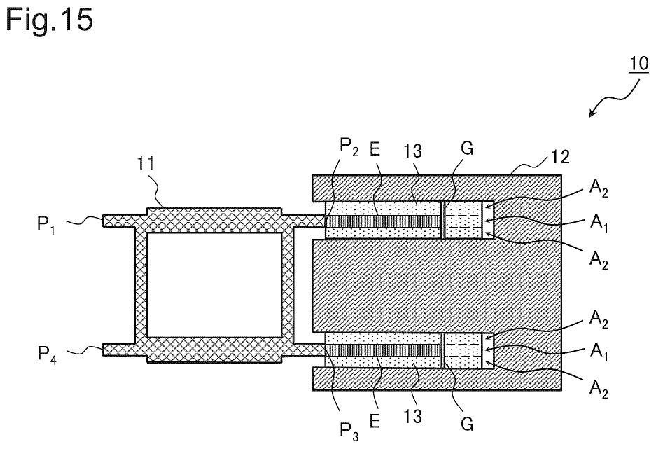

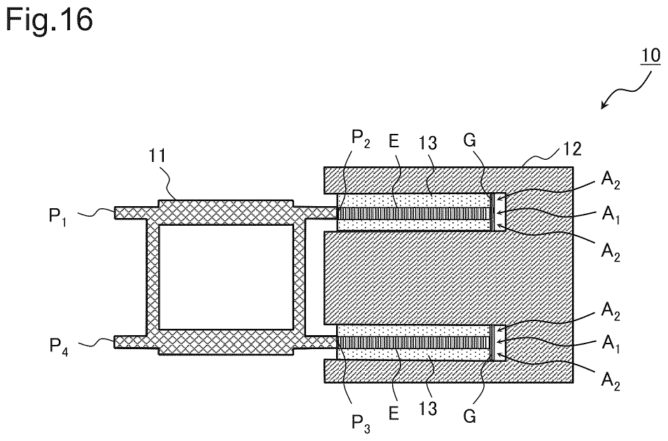

FIGS. 14 to 16 are conceptual diagrams illustrating an example of a conductor pattern formed on the variable stub according to the present disclosure. FIG. 14 illustrates a conductor pattern that minimizes the extension of the extended line E and grounds the extended line E via the grounded line G. FIG. 14 illustrates a state in which the line length of the variable stub 13 is minimum. FIG. 15 illustrates a conductor pattern that extends the extended line E and grounds the extended line E via the grounded line G. FIG. 16 illustrates a conductor pattern that maximizes the extension of the extended line E and grounds the extended line E via the grounded line G. FIG. 16 illustrates a state in which the line length of the variable stub 13 is maximum. As illustrated in FIGS. 14 to 16, the line length of the variable stub 13 can be continuously changed by controlling the phase transition of the insulating layer-metal phase of the vanadium dioxide VO₂ contained in the line formation layer 133.

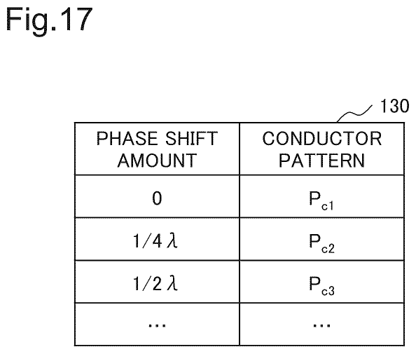

FIG. 17 is an example of a table (phase shift table 130) used to select a conductor pattern formed in the variable stub according to the present disclosure. The phase shift table 130 stores a conductor pattern P_{c} related to a desired phase shift amount. The conductor pattern P_{c} is associated with an address indicating a position of the heat generating element 132 caused to generate heat for forming the conductor pattern P_{c}. The conductor pattern P_{c1} is associated with the phase shift amount 0. The conductor pattern P_{c2} is associated with the phase shift amount ¼λ. The conductor pattern P_{c3} is associated with the phase shift amount ½λ. For example, a desired phase shift amount is set via an input device (not illustrated). The control circuit 17 selects the heat generation drive circuit 131 to be used for forming the conductor pattern P_{c} related to the set desired phase shift amount. As a result, a desired phase shift amount is set in the variable stub 13.

### Modified Example

Next, a modified example of the phase shifter according to the present disclosure will be described with reference to the drawings. Hereinafter, variations of the line formation layer included in the phase shifter will be described.

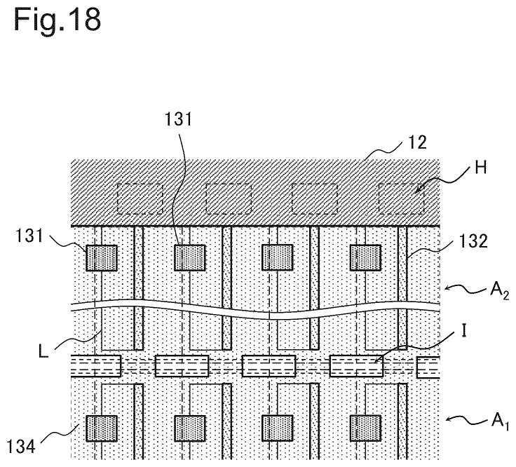

FIG. 18 is a conceptual diagram illustrating an example of a configuration of a phase shifter according to a first modified example of the present disclosure. FIG. 18 is a plan view of a portion of the variable stub viewed from an upper viewpoint. In the line formation layer 134 of the present modified example, an isolation opening I is formed in a portion between the extended line region A₁ and the grounded line region A₂. The isolation opening I is an opening penetrating the line formation layer 134. Since the line formation layer 134 of the present modified example includes the isolation opening I, thermal conduction between the extended line region A₁ and the grounded line region A₂ is reduced. According to the present modified example, the accuracy of the width of the extended line E formed in the extended line region A₁ is improved.

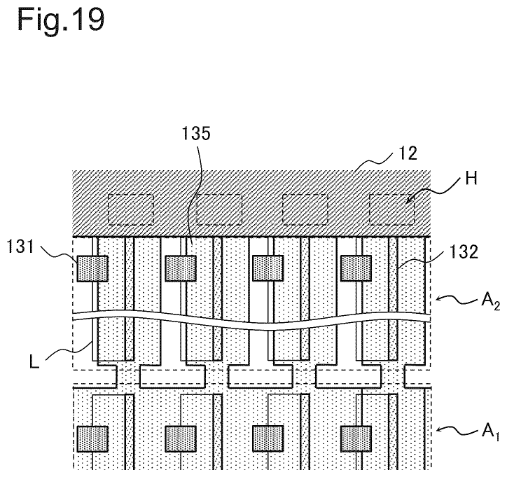

FIG. 19 is a conceptual diagram illustrating an example of a configuration of a phase shifter according to a second modified example of the present disclosure. FIG. 19 is a plan view of a portion of the variable stub viewed from an upper viewpoint. In the grounded line region A₂, the line formation layer 135 is separated for each column (up-down direction in the plane of drawing) associated with each heat generating element 132. That is, in the grounded line region A₂ of the line formation layer 135, the portion heated by the adjacent heat generating element 132 is thermally isolated. On the other hand, in the extended line region A1, the line formation layer 135 is not separated for each column (up-down direction in the plane of drawing) associated with each heat generating element 132. According to the present modified example, the edge (side end) of the extended line E formed in the extended line region A₁ can be accurately set. In addition, according to the present modified example, the edge (side end) of the grounded line G formed in the grounded line region A₂ can be accurately set.

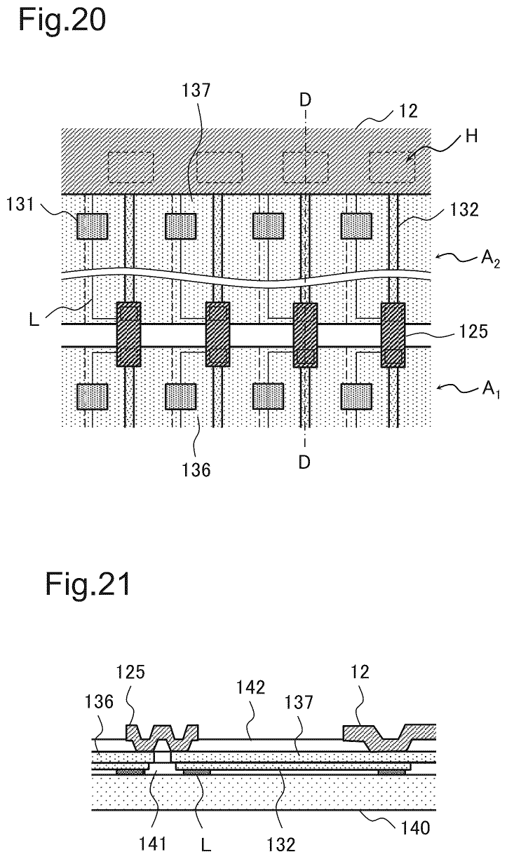

FIGS. 20 to 21 are conceptual diagrams illustrating an example of a configuration of a phase shifter according to a third modified example of the present disclosure. FIG. 20 is a plan view of a portion of the variable stub viewed from an upper viewpoint. FIG. 21 is a cross-sectional view taken along a cutting line D-D in FIG. 20. In the present modified example, the line formation layer 136 including the extended line region A₁ in which the extended line E is formed and the line formation layer 137 including the grounded line region A₂ in which the grounded line G is formed are separated. The line formation layer 136 included in the extended line region A₁ and the line formation layer 137 included in the grounded line region A₂ are electrically connected by a connection member 125. The material of the connection member 125 is not limited as long as it has electrical conductivity. The connection member 125 is preferably made of a material having high electrical conductivity and low thermal conductivity. For example, the connection member 125 may be made of a material containing vanadium dioxide VO₂. Since the line formation layer 136 and the line formation layer 137 of the present modified example are separated from each other, thermal conduction between the extended line region A₁ and the grounded line region A₂ is reduced. According to the present modified example, the accuracy of the width of the extended line E formed in the extended line region A₁ is improved.

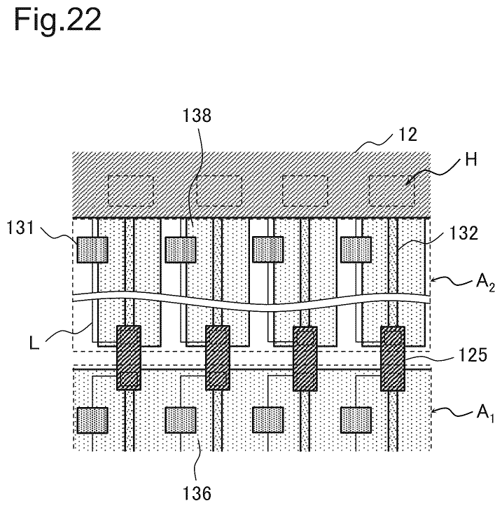

FIG. 22 is a conceptual diagram illustrating an example of a configuration of a phase shifter according to a fourth modified example of the present disclosure. FIG. 22 is a plan view of a portion of the variable stub viewed from an upper viewpoint. In the grounded line region A₂, the line formation layer 138 is formed for each heat generating element 132. The plurality of line formation layers 138 are separated from each other for each column (up-down direction in the plane of drawing) associated with each heat generating element 132. That is, in the grounded line region A₂, the line formation layer 138 heated by the adjacent heat generating element 132 is thermally isolated. On the other hand, in the extended line region A₁, the line formation layer 136 is not separated for each column (up-down direction in the plane of drawing) associated with each heat generating element 132. The line formation layer 136 included in the extended line region A₁ and a plurality of line formation layers 138 included in the grounded line region A₂ are electrically connected by the connection member 125. Similarly to the third modified example, the connection member 125 is not limited as long as it has electrical conductivity. Since the plurality of line formation layers 138 are separated from each other, thermal conduction between the extended line region A₁ and the grounded line region A₂ is reduced. According to the present modified example, the edge (side end) of the extended line E formed in the extended line region A₁ can be accurately set. In addition, according to the present modified example, the edge (side end) of the grounded line G formed in the grounded line region A₂ can be accurately set.

As described above, the phase shifter according to the present example embodiment includes the 90 degree hybrid circuit, the ground pattern, and the variable stub. The 90 degree hybrid circuit is a 90 degree hybrid circuit having two reflection ends. Two grooves in which variable stubs are disposed are formed in the ground pattern. The ground pattern is connected to the side ends of the variable stubs disposed in each of the two grooves. The variable stub has a line formation layer made of vanadium dioxide. One variable stub is disposed in each of the two grooves formed in the ground pattern. The variable stub is connected to each of the two reflection ends of the 90 degree hybrid circuit. The variable stub is extended from each of the two reflection ends.

The phase shifter of the present example embodiment includes a line formation layer made of vanadium dioxide. By performing temperature control, an extended line corresponding to the phase transition of the insulating phase-metal phase of vanadium dioxide is formed in the line formation layer. A continuous phase shift amount can be stably set in the line formation layer by controlling the line length of the extended line to be formed. Therefore, according to the phase shifter of the present example embodiment, a continuous phase shift change can be achieved with a stable phase shift amount.

In one aspect of the present example embodiment, the variable stub includes a plurality of heat generating elements and a plurality of heat generation drive circuits. The plurality of heat generating elements are arranged in an array form along one surface of the line formation layer. Each of the plurality of heat generation drive circuits is disposed one by one in association with each of the plurality of heat generating elements. Each of the plurality of heat generating elements is thermally connected to the line formation layer. Each of the plurality of heat generation drive circuits causes the heat generating element to generate heat to a temperature exceeding the phase transition temperature of vanadium dioxide contained in the line formation layer according to the selection of the heat generating element. According to the present aspect, a desired phase shift amount can be set by selecting a heat generating element according to the phase shift amount.

In one aspect of the present example embodiment, the line formation layer includes an extended line region and a grounded line region. The extended line region is extended from each of the two reflection ends of the 90 degree hybrid circuit. The grounded line region connects the extended line region and the ground pattern. According to the present aspect, a desired phase shift amount can be set by forming an extended line having a line length corresponding to the phase shift amount in the extended line region of the line formation layer.

In one aspect of the present example embodiment, an extended line extending from each of two reflection ends of the 90 degree hybrid circuit is formed in the extended line region. In the grounded line region, a grounded line for short circuiting the terminal end of the extended line formed in the extended line region to the ground pattern is formed. According to the present aspect, a desired phase shift amount can be set by forming an extended line having a line length corresponding to the phase shift amount in the extended line region of the line formation layer.

In one aspect of the present example embodiment, an extended line having a line length corresponding to a desired phase shift amount is formed in an extended line region. A grounded line connecting the terminal end of the extended line formed in the extended line region and the ground pattern is formed in the grounded line region. According to the present aspect, the short stub having a line length corresponding to a desired phase shift amount is formed.

In one aspect of the present example embodiment, in the line formation layer, an opening is formed between the extended line region and the grounded line region. In the line formation layer of the present aspect, thermal conduction between the extended line region and the grounded line region is reduced by the opening formed between the extended line region and the grounded line region. Therefore, according to the present aspect, the accuracy of the width of the extended line formed in the extended line region is improved.

In one aspect of the present example embodiment, the extended line region and the grounded line region are separated in the line formation layer. The extended line region and the grounded line region are electrically connected by the plurality of connection members arranged in association with the heat generating elements adjacent to each other in the direction perpendicular to the extending direction. In the line formation layer of the present aspect, the extended line region and the grounded line region are separated. In the line formation layer of the present aspect, thermal conduction between the extended line region and the grounded line region is reduced.

Therefore, according to the present aspect, the accuracy of the width of the extended line formed in the extended line region is improved.

In one aspect of the present example embodiment, a heat generation drive circuit that causes a heat generating element used for forming an extended line and a grounded line related to a conductor pattern related to a desired phase shift amount to generate heat is selected using a phase shift table in which the conductor pattern related to the phase shift amount is registered. In the line formation layer, an extended line and a grounded line related to the conductor pattern set using the phase shift table are formed. According to the present aspect, a desired phase shift amount can be easily set using the phase shift table.

### Second Example Embodiment

Next, an antenna device according to a second example embodiment will be described with reference to the drawings. A planar antenna of the present example embodiment includes a patch antenna, which is a type of planar antenna. Hereinafter, description of a transmission device for transmitting a radio wave from the planar antenna and a reception device for receiving a radio wave received by the planar antenna will be omitted. For example, the planar antenna of the present example embodiment is used for transmission and reception of electromagnetic waves in a high frequency band expected to be applied to mobile communication of Beyond 5 Generation (B5G) subsequent to 5 Generation (5G). For example, the planar antenna of the present example embodiment is used for transmission and reception of signals of millimeter waves and terahertz waves. The planar antenna of the present example embodiment may be used for transmission and reception of signals other than millimeter waves and terahertz waves.

The antenna device of the present example embodiment includes the phase shifter according to the first example embodiment. For example, the phase shifter is formed using a manufacturing process technology of micro Light Emitting Diode (LED) display. In addition, the planar antenna of the present example embodiment includes a switching element formed using a manufacturing process technology of a thin-film transistor (TFT). The planar antenna of the present example embodiment is manufactured by combining a manufacturing process technology of a micro LED display (micro LED process technology) and a manufacturing process technology of a thin film transistor (TFT process technology). The planar antenna of the present example embodiment may be manufactured using a technology other than the micro LED process technology and the TFT process technology.

### (Configuration)

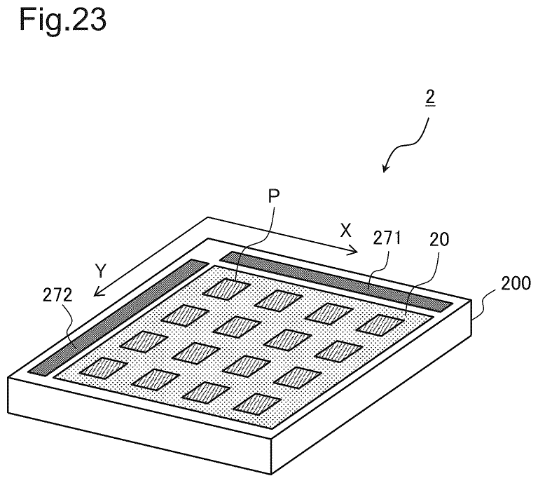

FIG. 23 is a conceptual diagram illustrating an example of a configuration of the antenna device according to the present disclosure. FIG. 23 illustrates an example of an external appearance of the antenna device. The antenna device 2 includes a planar antenna 200. An antenna array 20 is arranged on the upper surface of the planar antenna 200. The antenna array 20 includes a plurality of patch antennas P. The plurality of patch antennas P are arrayed in a two-dimensional array form. In the example of FIG. 23, the plurality of patch antennas P are arrayed along the X direction and the Y direction. The plurality of patch antennas P are phased arrayed. That is, the antenna device 2 functions as a phased array antenna.

A first drive circuit 271 and a second drive circuit 272 are mounted on the antenna device 2. The first drive circuit 271 and the second drive circuit 272 are circuits used to select the patch antenna P to be driven. An address associated to each of the patch antennas P can be selected by driving the first drive circuit 271 and the second drive circuit 272. The first drive circuit 271 and the second drive circuit 272 may be formed on the surface of the planar antenna 200 or may be formed inside the planar antenna 200.

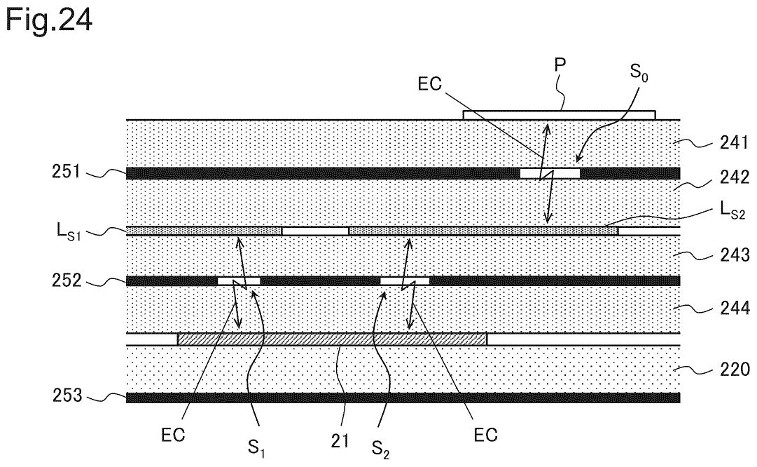

FIG. 24 is a conceptual diagram illustrating an example of a configuration of an antenna device according to the present disclosure. FIG. 24 is a cross-sectional view of the antenna device 2 taken along a cutting line passing through the patch antenna P. The antenna device 2 includes a patch antenna P, an insulating layer, a ground layer, a signal line layer, a substrate 220, and a phase shifter forming layer. The insulating layer includes a first insulating layer 241, a second insulating layer 242, a third insulating layer 243, and a fourth insulating layer 244. The ground layer includes a first ground layer 251, a second ground layer 252, and a third ground layer 253. The signal line layer includes a signal line Lₛ₁ and a signal line Lₛ₂. The phase shifter 21 associated with the patch antenna P is formed in the phase shifter forming layer. FIG. 24 illustrates an example in which the signal line layer and the patch antenna P are formed in different layers. The antenna device according to the present example embodiment may be configured as a coplanar side antenna in which the signal line layer and the patch antenna P are formed in the same layer. The third ground layer 253 may not be provided, and substrate 220 may be disposed at a position of the fourth insulating layer 244.

The antenna array 20 is disposed on the upper surface of the first insulating layer 241. The antenna array 20 includes a plurality of patch antennas P. Although a single patch antenna P is illustrated in FIG. 24, the antenna device 2 includes a plurality of patch antennas P. The plurality of patch antennas P are arranged in a lattice shape along two directions orthogonal to each other. The plurality of patch antennas P are phased arrayed. The patch antenna P is a plate-shaped radiation element. For example, the patch antenna P has a square shape. The shape of the patch antenna P is not limited to a square shape, and may be a circular shape or other shapes.

The patch antenna P is power supplied by an electromagnetic coupling power supplying method. The patch antenna P is electromagnetically coupled to the signal line Lₛ₂ formed below the second insulating layer 242 via the slot S₀. The patch antenna P is excited by electromagnetic coupling between the patch antenna P and the signal line Lₛ₂ via the slot S₀. The impedance can be matched by arranging the open end of the signal line Lₛ₂ at a position away from immediately below the slot S₀ by about ¼ wavelength and adjusting the dimension of the slot S₀. For example, the shape of the slot S₀ is rectangular. For example, the shape of the slot S₀ may be a shape other than a rectangle, such as a dog-bone shape.

The patch antenna P has a structure equivalent to that of a microstrip line whose both ends are opened. The resonance frequency of the patch antenna P is an integral multiple of ½ of a wavelength equivalent to the length of one side of the patch antenna P. The size of the patch antenna P is set according to the wavelength of the transmission target radio wave. Since the patch antenna P is an open type resonator that resonates at a resonance frequency, the Q factor decreases due to radio wave radiation. In order to avoid a decrease in the Q factor due to radio wave radiation and to operate the patch antenna P as a resonator, it is preferable that the dielectric constants of the materials of the insulating layer and the substrate 220 are as high as possible. As the dielectric constants of the materials of the insulating layer and the substrate 220 become higher, the transmission of radio waves can be further suppressed. When the material of the insulating layer and the substrate 220 is a high dielectric, the thickness of the insulating layer and the substrate 220 and the width of the patch antenna P are set to be sufficiently small with respect to the wavelength of the radio wave used in communication. For example, in a case where the material of the insulating layer and the substrate 220 is a low dielectric, a microstrip antenna can be configured by increasing the thickness of the insulating layer and the width of the patch antenna P with respect to the wavelength of the transmission target radio wave to increase the radiation amount.

The patch antenna P is preferably configured such that a signal (radio wave) is easily radiated into space. On the other hand, an internal wiring such as a signal line or a wiring is configured such that a signal is less likely to be radiated. That is, it is better the smaller the dielectric constant required at the periphery of the patch antenna P, and it is better the larger the better the dielectric constant required around the internal wiring. Therefore, it is preferable that different manufacturing processes are applied to the structure around the patch antenna P and the structure around the internal wiring. For example, by applying a method of forming a structure around the patch antenna P by a liquid crystal process and forming a structure around the internal wiring by a thin film process, the structure of the antenna device 2 of the present example embodiment can be achieved.

The first insulating layer 241 forms a surface of the antenna device 2. The first insulating layer 241 is stacked on the upper surface of the first ground layer 251. For example, the material of the first insulating layer 241 is glass, glass epoxy, tetrafluoroethylene, epoxy, or the like. As long as communication radio waves can be transmitted and received, the first insulating layer 241 may be made of a material other than glass, glass epoxy, tetrafluoroethylene, epoxy, or the like.

The first ground layer 251 is stacked on the upper surface of the second insulating layer 242. The first insulating layer 241 is stacked on an upper surface of the first ground layer 251. For example, a material of the first ground layer 251 is metal (including alloy) such as copper, aluminum, and chromium. The potential of the first ground layer 251 is a ground potential. An opening is formed in the first ground layer 251. The opening formed in the first ground layer 251 is referred to as a slot S₀. The slot So is formed below the patch antenna P. The signal line Lₛ₂ is extended immediately below the slot S₀. The signal propagated through the signal line Lₛ₂ is propagated to the patch antenna P by electromagnetic coupling EC between the signal line Lₛ₂ and the patch antenna P.

The second insulating layer 242 is formed above the signal line layer. The first ground layer 251 is formed on an upper surface of the second insulating layer 242. An opening (air gap) may be formed in a portion of the second insulating layer 242 corresponding to a position below the patch antenna P. When the air gap is formed, the dielectric constant between the signal line Lₛ₂ and the patch antenna P lowers. That is, in order to lower the dielectric constant between the signal line Lₛ₂ and the patch antenna P, an air gap merely needs to be formed. For example, the material of the second insulating layer 242 is glass, glass epoxy, tetrafluoroethylene, epoxy, or the like. As long as communication radio waves can be transmitted and received, the second insulating layer 242 may be made of a material other than glass, glass epoxy, tetrafluoroethylene, epoxy, or the like.

The signal line layer is formed on the upper surface of the third insulating layer 243. The second insulating layer 242 is stacked on the upper surface of the signal line layer. The signal line layer includes a signal line Lₛ₁ and a signal line Lₛ₂. The signal line Lₛ₁ (first signal line) is connected to a signal source (not illustrated). The signal sent out from the signal source is propagated to the signal line Lₛ₁. The signal before the phase shift is propagated to the signal line Lₛ₁. The signal line Lₛ₂ (second signal line) is extended in such a way as to pass below the slot S₀ of the first ground layer 251. Capacitances corresponding to the dielectric constants of the first insulating layer 241 and the second insulating layer 242 are formed between the signal line Lₛ₂ and the patch antenna P. In the signal line Lₛ₂, the phase-shifted signal phase-shifted by the phase shifter 21 is propagated to the patch antenna P by the electromagnetic coupling EC via the slot S₀.

The third insulating layer 243 is formed above the second ground layer 252. A signal line layer is formed on the upper surface of the third insulating layer 243. For example, the material of the third insulating layer 243 is glass, glass epoxy, tetrafluoroethylene, epoxy, or the like. As long as communication radio waves can be transmitted and received, the third insulating layer 243 may be made of a material other than glass, glass epoxy, tetrafluoroethylene, epoxy, or the like.

The second ground layer 252 is stacked on the upper surface of the fourth insulating layer 244. The second insulating layer 242 is stacked on an upper surface of the second ground layer 252. For example, a material of the second ground layer 252 is metal (including alloy) such as copper, aluminum, and chromium. The potential of the second ground layer 252 is a ground potential. Two types of openings are formed in second ground layer 252. The two types of openings formed in the second ground layer 252 are referred to as a slot S₁ and a slot S₂. The slot S₁ is formed at a position between the signal line Lₛ₁ and the phase shifter 21. The slot S₂ is formed at a position between the signal line Lₛ₂ and the phase shifter 21. Capacitances corresponding to the dielectric constants of the third insulating layer 243 and the fourth insulating layer 244 are formed between the signal line Lₛ₁ and the phase shifter 21. Similarly, capacitances corresponding to the dielectric constants of the third insulating layer 243 and the fourth insulating layer 244 are formed between the signal line Lₛ₂ and the phase shifter 21. The signal propagated through the signal line Lₛ₁ is propagated to the phase shifter 21 by the electromagnetic coupling EC via the slot S₁. The signal propagated to the phase shifter 21 is phase-shifted by the phase shift amount set in the phase shifter 21 and propagated to the signal line Lₛ₂ by the electromagnetic coupling EC via the slot S₂.

The fourth insulating layer 244 is formed above the phase shifter forming layer. The second ground layer 252 is formed on an upper surface of the fourth insulating layer 244. For example, the material of the fourth insulating layer 244 is glass, glass epoxy, tetrafluoroethylene, epoxy, or the like. As long as communication radio waves can be transmitted and received, the fourth insulating layer 244 may be made of a material other than glass, glass epoxy, tetrafluoroethylene, epoxy, or the like.

In the phase shifter forming layer, the phase shifter 21 is formed for each patch antenna P. The phase shifter forming layer is formed on the upper surface of the substrate 220. The fourth insulating layer 244 is formed on the upper surface of the phase shifter forming layer. Two types of openings (slot S₁, slot S₂) are formed in the second ground layer 252 above phase shifter 21. The signal line Lₛ₁ is disposed above the phase shifter 21 via the slot S₁. The signal line Lₛ₂ is disposed above the phase shifter 21 via the slot S₂. The signal propagated through the signal line Lₛ₁ is propagated to the phase shifter 21 by the electromagnetic coupling EC via the slot S₁. The signal propagated to the phase shifter 21 is phase-shifted by the phase shift amount set in the phase shifter 21 and propagated to the signal line Lₛ₂ by the electromagnetic coupling EC via the slot S₂.

The substrate 220 is disposed below the phase shifter forming layer. On the upper surface of the substrate 220, a matrix circuit, TFT wiring, and a phase shifter 21 are formed. The matrix circuit has a structure in which a plurality of thin-film transistors (TFT) are arranged in a two-dimensional array form. For example, the TFT included in the matrix circuit is formed using a TFT process technology. The TFT wiring includes a plurality of selection lines used to select a phase shifter 21 and a plurality of data lines used to write phase shift data to the phase shifter 21. For example, a material of the substrate 220 is glass, glass epoxy, tetrafluoroethylene, epoxy, or the like. As long as communication radio waves can be transmitted and received, the substrate 220 may be made of a material other than glass, glass epoxy, tetrafluoroethylene, epoxy, or the like.

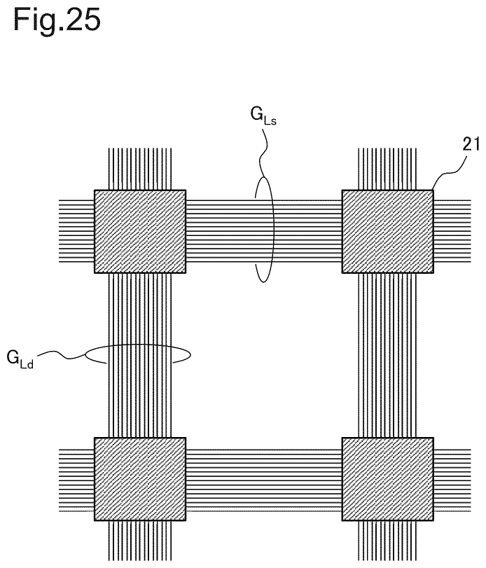

FIG. 25 is a conceptual diagram illustrating an example of a matrix circuit formed on an upper surface of a substrate according to the present disclosure. FIG. 25 is a plan view of a surface on which the matrix circuit is formed as viewed from an upper viewpoint. TFT wiring is formed in the phase shifter forming layer. The TFT wiring includes a selection line group G_{Ls} including a plurality of selection lines and a data line group G_{Ld} including a plurality of data lines. Each of the plurality of selection lines included in the selection line group G_{Ls} is used to select the phase shifter 21. Each of the plurality of data lines included in the data line group G_{La} is used for propagation of a signal radiated via the phase shifter 21. The TFT wiring may include wiring other than the selection line group G_{Ls} and the data line group G_{Ld}.

The third ground layer 253 is disposed on the lower surface of the substrate 220. The third ground layer 253 is made of a conductor. For example, a material of the third ground layer 253 is metal (including alloy) such as copper, aluminum, and chromium. The potential of the third ground layer 253 is a ground potential. Therefore, a capacitance corresponding to the dielectric constant of the substrate 220 is formed between the phase shifter 21 and the third ground layer 253.

A signal supplied from a signal source (not illustrated) to the signal line Lₛ₁ is propagated to the phase shifter 21 by electromagnetic coupling via the slot S₁. The signal propagated to phase shifter 21 is phase-shifted according to the phase shift amount set in phase shifter 21. The phase-shifted signal is propagated to the signal line Lₛ₂ from the phase shifter 21 by electromagnetic coupling via the slot S₂. The signal phase-shifted by the phase shifter 21 is propagated through the signal line Lₛ₂ and reaches below the patch antenna P. The signal that has reached below the patch antenna P is propagated from the signal line Lₛ₂ to the patch antenna P by electromagnetic coupling via the slot S₀. The signal propagated to the patch antenna P is transmitted as a radio signal from the phased array antenna configured by the plurality of patch antennas P.

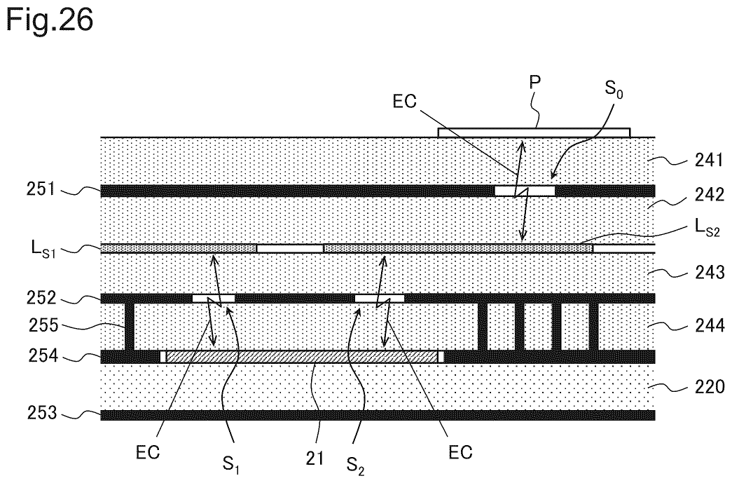

FIG. 26 is a conceptual diagram illustrating an example of a configuration of an antenna device according to the present disclosure. The antenna device illustrated in FIG. 26 is different from the antenna device illustrated in FIG. 24 in that a fourth ground layer is formed on the same layer as the phase shifter forming layer. The fourth ground layer 254 is electrically connected to third ground layer 253 by a plurality of vias 255 penetrating fourth insulating layer 244. The plurality of vias 255 are formed inside the through hole penetrating the fourth insulating layer 244. The fourth ground layer 254 is grounded to the same potential as the third ground layer 253 by the plurality of vias 255. As compared with the configuration of FIG. 24, the configuration of FIG. 26 can be grounded more reliably inside the antenna device.

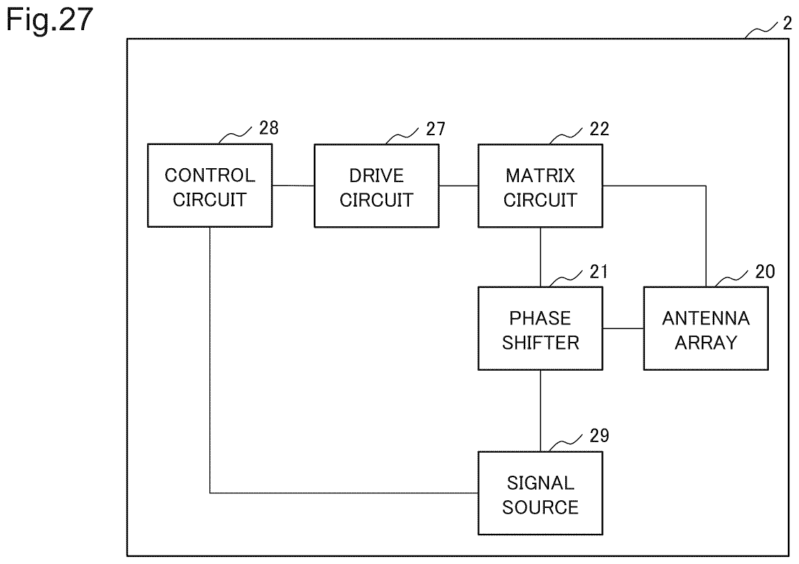

FIG. 27 is a block diagram illustrating an example of a functional configuration of the antenna device according to the present disclosure. The antenna device 2 includes an antenna array 20, a phase shifter 21, a matrix circuit 22, a control circuit 28, and a signal source 29.

The matrix circuit 22 has a configuration in which a plurality of thin-film transistors (TFT) are arrayed in a two-dimensional array form. The matrix circuit 22 is formed using a TFT process technology. Each of the plurality of TFTs included in the matrix circuit 22 is associated with one of the plurality of patch antennas P included in the antenna array 20. For example, the TFT includes a semiconductor layer such as amorphous silicon or polysilicon. Each of the plurality of pixels formed in the matrix circuit 22 is associated with the patch antenna P.

The phase shifter 21 is disposed for each antenna unit. The phase shifter 21 is the phase shifter 10 according to the first example embodiment. The phase shifter 21 is associated with the patch antenna P. The heat generation drive circuit (not illustrated) included in the phase shifter 21 is associated with each of the plurality of pixels formed in the matrix circuit 22. The heat generating element (not illustrated) included in the phase shifter 21 generates heat in accordance with selection of the heat generation drive circuit. An extended line having a line length corresponding to a desired phase shift amount is set in a line formation layer (not illustrated) included in the phase shifter 21. The line length of the extended line is adjusted according to the set conductor pattern. As a result, a phase shift amount corresponding to the line length of the extended line is set in the phase shifter 21.

The drive circuit 27 includes a first drive circuit 271 and a second drive circuit 272. The first drive circuit 271 is a circuit for performing addressing in the X direction. The second drive circuit 272 is a circuit for performing addressing in the Y direction. The drive circuit 27 drives the TFTs included in the matrix circuit 22 under the control of the control circuit 28. The drive circuit 27 individually drives the plurality of TFTs included in the matrix circuit 22.

The control circuit 28 drives the drive circuit 27 according to an external control signal. The control circuit 28 drives the drive circuit 27 by an active matrix drive system. The control circuit 28 drives the first drive circuit 271 and the second drive circuit 272 in conjunction with each other to designate an address associated with each patch antenna P. In addition, the control circuit 28 outputs a control signal from the outside to the signal source 29.

For example, the control circuit 28 is achieved by a microcomputer or a microcontroller. For example, the control circuit 28 includes a Central Processing Unit (CPU), a Random Access Memory (RAM), a Read Only Memory (ROM), a flash memory, and the like. The control circuit 28 executes control and process corresponding to a program stored in advance. The control circuit 28 executes control and process corresponding to a program according to a preset schedule and timing, an external control instruction, and the like. For example, the control circuit 28 controls the antenna array 20 including the plurality of patch antennas P included in the planar antenna 200 to transmit a radio wave having directivity from the antenna array 20. As described above, the antenna array 20 is used as a phased array antenna.

The signal source 29 is connected to the phase shifter 21 via a signal line. In addition, the signal source 29 is connected to the control circuit 28. The signal source 29 transmits a signal to the phase shifter 21 under the control of the control circuit 28. The signal source 29 may be configured to receive a signal from the outside without passing through the control circuit 28.

The signal reaching the signal input unit of the phase shifter 21 through the signal line (not illustrated) connected to the TFT in the ON state is phase-shifted by the phase shift amount set in the phase shifter 21. The phase-shifted signal is propagated from the signal line to the patch antenna P by electromagnetic coupling. The radio wave derived from the signal propagated to the patch antenna P is transmitted from the patch antenna P. Furthermore, the radio wave transmitted from the patch antenna P is based on a signal output from a transmission circuit (not illustrated). The information included in the signal is not particularly limited.

In addition, the radio wave received by the patch antenna P is received according to the capacitance based on the dielectric constant of the dielectric such as the insulating layer or the TFT substrate interposed between the patch antenna P and the signal line. The phase of the received radio wave is phase-shifted by the phase shift amount set in phase shifter 21. The phase-shifted signal is received by a reception circuit (not illustrated) through the signal line. Information included in the signal received by the reception circuit is decoded by a decoder (not illustrated).

As described above, the antenna device according to the present example embodiment includes the phase shifter according to the first example embodiment and the antenna array in which a plurality of patch antennas are arranged in a two-dimensional array form. The phase shifter is arranged in association with each of the plurality of patch antennas.

The antenna device of the present example embodiment includes a phase shifter having a line formation layer made of vanadium dioxide. By performing temperature control, an extended line having a line length corresponding to the phase transition of the insulating phase-metal phase of vanadium dioxide is formed in the line formation layer. A continuous phase shift amount can be stably set in the line formation layer by controlling the line length of the extended line to be formed. In the plurality of phase shifters included in the antenna device of the present example embodiment, a continuous phase shift change is achieved with a stable phase shift amount. An optional phase shift amount can be set for each of the plurality of patch antennas. Therefore, according to the antenna device of the present example embodiment, a phased array antenna capable of transmitting a radio wave having directivity in an optional direction can be achieved.

### Third Example Embodiment

Next, a phase shifter according to a third example embodiment will be described with reference to the drawings. The phase shifter of the present example embodiment has a configuration obtained by simplifying the phase shifter of the first example embodiment.

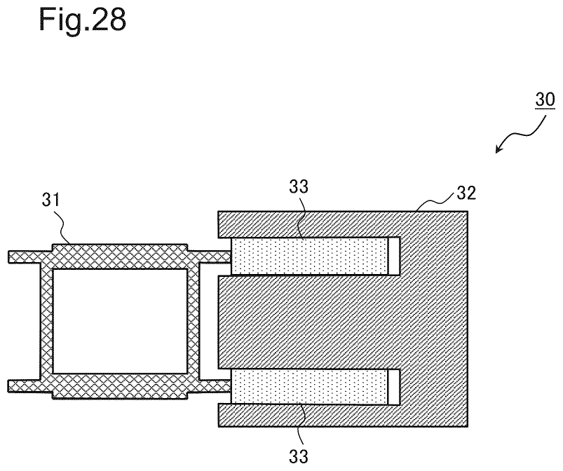

FIG. 28 is a conceptual diagram illustrating an example of a configuration of a phase shifter according to the present disclosure. The phase shifter 30 includes a 90 degree hybrid circuit 31, a ground pattern 32, and a variable stub 33.

The 90 degree hybrid circuit 31 has two reflection ends. The ground pattern 32 is formed with a groove in which the variable stub 33 is disposed, and is connected to a side end of the variable stub 33 disposed in the groove. The variable stub 33 has a line formation layer made of vanadium dioxide and is extended from each of the two reflection ends.

The phase shifter of the present example embodiment includes a line formation layer made of vanadium dioxide. By performing temperature control, an extended line having a line length corresponding to the phase transition of the insulating phase-metal phase of vanadium dioxide is formed in the line formation layer. A continuous phase shift amount can be stably set in the line formation layer by controlling the line length of the extended line to be formed. Therefore, according to the phase shifter of the present example embodiment, a continuous phase shift change can be achieved with a stable phase shift amount.

### (Hardware)

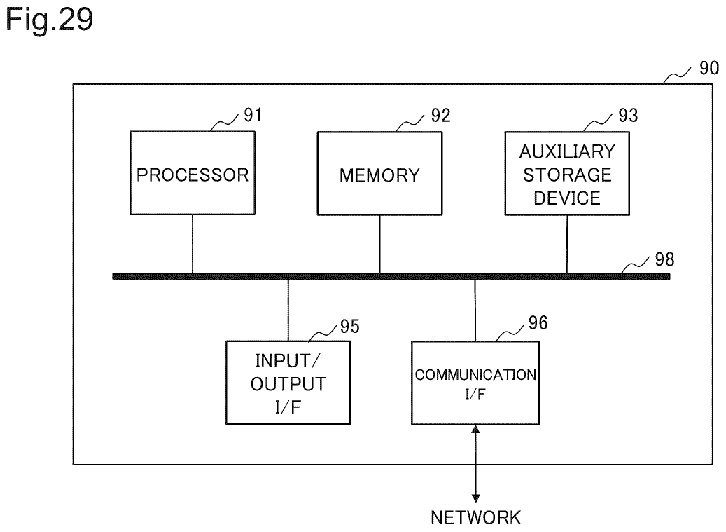

Next, a hardware configuration for executing control and process in the present disclosure will be described with reference to the drawings. Here, an example of such a hardware configuration is the information processing device 90 (computer) in FIG. 29. The information processing device 90 in FIG. 29 is a configuration example for executing control and process in the present disclosure, and does not limit the scope of the present disclosure.

As illustrated in FIG. 29, the information processing device 90 includes a processor 91, a memory 92, an auxiliary storage device 93, an input/output interface 95, and a communication interface 96. In FIG. 29, the interface is abbreviated as an interface (I/F). The processor 91, the memory 92, the auxiliary storage device 93, the input/output interface 95, and the communication interface 96 are connected to each other via a bus 98 in such a way as to be able to communicate data. In addition, the processor 91, the memory 92, the auxiliary storage device 93, and the input/output interface 95 are connected to a network such as the Internet or an intranet via the communication interface 96.

The processor 91 develops a program (command) stored in the auxiliary storage device 93 or the like in the memory 92. For example, the program is a software program for executing control and process in the present disclosure. The processor 91 executes the program developed in the memory 92. The processor 91 executes control and process in the present disclosure by executing a program.

The memory 92 is a storage device having an area in which a program is developed. A program stored in the auxiliary storage device 93 or the like is developed in the memory 92 by the processor 91. The memory 92 is achieved by, for example, a volatile memory such as a Dynamic Random Access Memory (DRAM). In addition, a nonvolatile memory such as a Magnetoresistive Random Access Memory (MRAM) may be applied as the memory 92.

The auxiliary storage device 93 stores various data such as programs. For example, the auxiliary storage device 93 is achieved by a local disk such as a hard disk or a flash memory. Various data may be stored in the memory 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a standard or a specification. The input/output interface 95 and the communication interface 96 may be shared as an interface to connect to an external device.

Input devices such as a keyboard, a mouse, and a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and process in the present disclosure. The hardware configuration of FIG. 29 is an example of a hardware configuration for executing control and process in the present disclosure, and does not limit the scope of the present disclosure. A program for causing a computer to execute control and process in the present disclosure is also included in the scope of the present disclosure.

A program recording medium on which a program for executing process in the present example embodiment is recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium.

The components in the present disclosure may be optionally combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all the above example embodiments may be described as the following supplementary notes, but are not limited to the following.

### (Supplementary Note 1)

A phase shifter comprising:

a 90 degree hybrid circuit having two reflection ends,

a variable stub having a line formation layer made of vanadium dioxide and extending from each of the two reflection ends, and

a ground pattern formed with a groove in which the variable stub is disposed and connected to a side end of the variable stub disposed in the groove.

### (Supplementary Note 2)

The phase shifter according to supplementary note 1, wherein the variable stub includes:

a plurality of heat generating elements arranged in an array form along one surface of the line formation layer, and

a heat generation drive circuit arranged in association with each of the plurality of heat generating elements,

each of the plurality of heat generating elements is

thermally connected to the line formation layer, and

each of the plurality of heat generation drive circuits

causes the heat generating element to generate heat to a temperature exceeding a phase transition temperature of vanadium dioxide contained in the line formation layer according to selection of the heat generating element.

### (Supplementary Note 3)

The phase shifter according to supplementary note 2, wherein

the line formation layer includes:

an extended line region extending from each of the two reflection ends of the 90 degree hybrid circuit, and

a grounded line region connecting the extended line region and the ground pattern.

### (Supplementary Note 4)

The phase shifter according to supplementary note 3, wherein

the extended line region is

formed with an extended line extending from each of the two reflection ends of the 90 degree hybrid circuit, and

the grounded line region is

formed with a grounded line that short circuits a terminal end of the extended line formed in the extended line region to the ground pattern.

### (Supplementary Note 5)

The phase shifter according to supplementary note 4, wherein

the extended line having a line length corresponding to a desired phase shift amount is formed in the extended line region, and

the grounded line connecting the terminal end of the extended line formed in the extended line region and the ground pattern is formed in the grounded line region.

### (Supplementary Note 6)

The phase shifter according to supplementary note 3, wherein an opening is formed in the line formation layer between the extended line region and the grounded line region.

### (Supplementary Note 7)

The phase shifter according to supplementary note 4, wherein

the line formation layer is

separated in association with each of the plurality of heat generating elements arranged in an array form in an extending direction of the extended line.

### (Supplementary Note 8)

The phase shifter according to supplementary note 4, wherein

the heat generation drive circuit that causes the heat generating element used for forming the extended line and the grounded line related to a conductor pattern related to a desired phase shift amount to generate heat is selected using a phase shift table in which the conductor pattern related to the phase shift amount is registered, and

the extended line and the grounded line related to the conductor pattern set by using the phase shift table are formed in the line formation layer.

### (Supplementary Note 9)

The phase shifter according to supplementary note 1, wherein

the ground pattern is

formed with two grooves in which the variable stubs are disposed, and

the variable stub is

disposed in each of the two grooves formed in the ground pattern, and connected to each of the two reflection ends of the 90 degree hybrid circuit.

### (Supplementary Note 10)

An antenna device comprising:

the phase shifter according to any one of supplementary notes 1 to 9, and

an antenna array in which a plurality of patch antennas are arrayed in a two-dimensional array form, wherein

the phase shifter is

disposed in association with each of the plurality of patch antennas.

1. A phase shifter comprising:
a 90 degree hybrid circuit having two reflection ends;
a variable stub having a line formation layer made of vanadium dioxide and extending from each of the two reflection ends, and
a ground pattern formed with a groove in which the variable stub is disposed and connected to a side end of the variable stub disposed in the groove.

2. The phase shifter according to claim 1, wherein
the variable stub includes
a plurality of heat generating elements arranged in an array form along one surface of the line formation layer, and
a heat generation drive circuit arranged in association with each of the plurality of heat generating elements, and wherein
each of the plurality of heat generating elements is thermally connected to the line formation layer, and
each of the plurality of heat generation drive circuits is configured to cause the heat generating element to generate heat to a temperature exceeding a phase transition temperature of vanadium dioxide contained in the line formation layer according to selection of the heat generating element.

3. The phase shifter according to claim 2, wherein
the line formation layer includes
an extended line region extending from each of the two reflection ends of the 90 degree hybrid circuit, and
a grounded line region connecting the extended line region and the ground pattern.

4. The phase shifter according to claim 3, wherein
the extended line region is formed with an extended line extending from each of the two reflection ends of the 90 degree hybrid circuit, and
the grounded line region is formed with a grounded line that short circuits a terminal end of the extended line formed in the extended line region to the ground pattern.

5. The phase shifter according to claim 4, wherein
the extended line having a line length corresponding to a desired phase shift amount is formed in the extended line region, and
the grounded line connecting the terminal end of the extended line formed in the extended line region and the ground pattern is formed in the grounded line region.

6. The phase shifter according to claim 3, wherein
an opening is formed in the line formation layer between the extended line region and the grounded line region.

7. The phase shifter according to claim 4, wherein
the extended line region and the grounded line region are separated in the line formation layer, and
the extended line region and the grounded line region are electrically connected by a plurality of connection members arranged in association with the heat generating elements adjacent to each other in a direction perpendicular to an extending direction.

8. The phase shifter according to claim 4, wherein
the heat generation drive circuit that causes the heat generating element used for forming the extended line and the grounded line related to a conductor pattern related to a desired phase shift amount to generate heat is selected using a phase shift table in which the conductor pattern related to the phase shift amount is registered, and
the extended line and the grounded line related to the conductor pattern set by using the phase shift table are formed in the line formation layer.

9. The phase shifter according to claim 1, wherein
the ground pattern is
formed with two grooves in which the variable stubs are disposed, and
the variable stub is
disposed in each of the two grooves formed in the ground pattern, and
connected to each of the two reflection ends of the 90 degree hybrid circuit.

10. An antenna device comprising:
the phase shifter according to claim 1; and
an antenna array in which a plurality of patch antennas are arrayed in a two-dimensional array form; wherein
the phase shifter is disposed in association with each of the plurality of patch antennas.
